(19) United States
(12) Patent Application Publication
(10) Pub. No.: US 2022/0333342 A1
(43) Pub. Date: Oct. 20, 2022

(54) WORK MACHINE AND CONTROL METHOD FOR WORK MACHINE

(71) Applicant: KOMATSU LTD., Tokyo (JP)

(72) Inventors: Masashi KATOH, Tokyo (JP); Yuuki KOBAYASHI, Tokyo (JP); Keisuke KUBOTA, Tokyo (JP)

(21) Appl. No.: 17/639,379

(22) PCT Filed: Sep. 15, 2020
(86) PCT No.: PCT/JP2020/034853

§ 371 Date: Mar. 1, 2022

(30) Foreign Application Priority Data
Oct. 11, 2019 (JP) 2019-187840

(51) Int. Cl. E02F 9/20; E02F 9/26

(52) U.S. Cl. CPC E02F 9/205; E02F 9/264; E02F 9/261; E02F 9/2004

(57) ABSTRACT

In the hydraulic excavator, the control unit outputs the drive signals, which gives the motion corresponding to the motion of the hydraulic cylinder, the revolving motor of the revolving unit and the traveling device to the work implement operating lever, the right work implement operating lever and the traveling lever, to the drive section. The control section outputs the control signals based on the motion of the left work implement operating lever the right work implement operating lever or the traveling lever operated by the operator when the motion of the left work implement operating lever, the right work implement operating lever or the traveling lever operated by the operator is different from the motion corresponding to the motion of the hydraulic cylinder, the revolving motor of the revolving unit and the traveling device.

### CROSS-REFERENCE TO RELATED APPLICATIONS

This application is a U.S. National stage application of International Application No. PCT/JP2020/034853, filed on Sep. 15, 2020. This U.S. National stage application claims priority under 35 U.S.C. § 119(a) to Japanese Patent Application No. 2019-187840, filed in Japan on Oct. 11, 2019, the entire contents of which are hereby incorporated herein by reference.

### BACKGROUND

### Technical Field

The present invention relates to a work machine and a control method for a work machine.

### Background Art

The hydraulic excavator, which is an example of a work machine, is provided with a traveling lever for moving the traveling device forward or backward, and two work implement operating levers for revolving the revolving unit and operating the work implement. The hydraulic excavator is often provided with a plurality of operating levers.

For example, Patent Literature 1 Japanese Patent Application H05-306532 discloses a hydraulic excavator that is automatically operated when a series of monotonous operation are repeated.

### SUMMARY

However, since the operation is not limited to monotonous work at the construction site, manual work by the operator is also required, but it is difficult to teach the operation to a beginner operator.

An object of the present invention is to provide a work machine and a control method for a work machine, which makes it easy for an operator to confirm operation of an operating lever.

The work machine of the disclosure includes an operating member, a drive section, and a controller. The drive section operates the operating member. The controller outputs a control signal to operate a traveling device of the work machine or an actuator of a work implement. The controller outputs a drive signal, which gives a motion corresponding to a motion of the actuator to the operating member, to the drive section operating the operating member based on the drive signal. When a motion of the operating member operated by an operator is different from the motion corresponding to the motion of the actuator, the controller outputs the control signal based on the motion of the operating member operated by the operator.

The control method for the work machine of the disclosure includes a first output step, a second output step, a determination step, and a third output step. The first output step outputs a control signal to operate an actuator. The second output step outputs a drive signal, which gives a motion corresponding to a motion of the actuator to an operating member, to a drive section driving the operating member. The determination step determines whether or not a motion of the operating member operated by an operator is different from the motion corresponding to the motion of the actuator. When it is determined that they are different, the third output step outputs the control signal based on the motion of the operating member operated by the operator.

According to the present disclosure, it is possible to provide a work machine and a control method for controlling a work machine that make it easy for an operator to confirm operation of an operating lever.

### BRIEF DESCRIPTION OF THE DRAWINGS

FIG. 1 is a perspective view of the hydraulic excavator according to the first embodiment of the present disclosure.

FIG. 2 is a perspective view showing the inside of a cab of the hydraulic excavator of FIG. 1.

FIG. 3 is an external perspective view showing a traveling lever unit of FIG. 2.

FIG. 4 is a cross-sectional view from the arrow direction of the BB′ line of FIG. 3.

FIG. 5 is a perspective view showing an external configuration of the left work implement operating lever unit of FIG. 3.

FIG. 6 is a perspective view schematically showing an internal configuration of the left work implement operating lever unit of FIG. 4.

FIG. 7 is a cross-sectional view from the arrow direction of the AA′ line of FIG. 5.

FIG. 8 is a block diagram showing a control system of the hydraulic excavator of FIG. 1.

FIG. 9 is a flow chart showing a control method for the hydraulic excavator of FIG. 1.

FIG. 10 is a block diagram showing a control system for a hydraulic excavator according to a second embodiment of the present disclosure.

### DETAILED DESCRIPTION OF THE INVENTION

Hereinafter, the hydraulic excavator 1 (an example of a work machine) according to the embodiment of the present invention will be described with reference to the drawings.

### Embodiment 1

<Configuration>

(Overview of the Configuration of the Hydraulic Excavator 1)

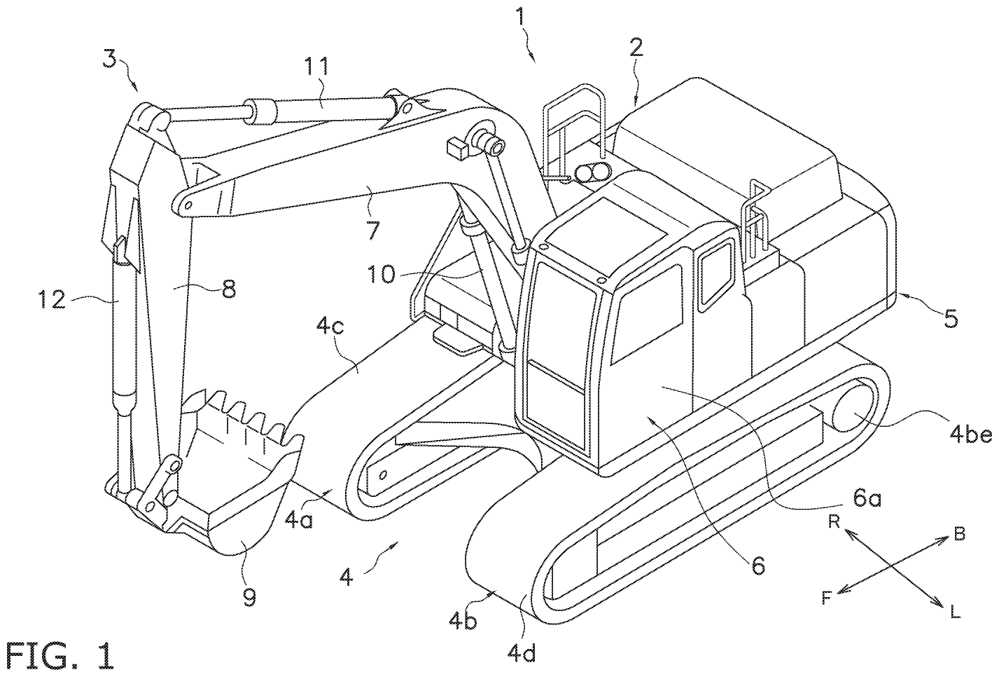

FIG. 1 is a schematic view showing the configuration of the hydraulic excavator 1 of the present embodiment.

The hydraulic excavator 1 includes a vehicle main body 2 and a work implement 3. As shown in FIG. 1, the vehicle main body 2 includes a traveling unit 4 and a revolving unit 5. The traveling unit 4 includes a pair of traveling devices 4a and 4b. Each of the traveling devices 4a and 4b includes tracks 4c and 4d, and the hydraulic excavator 1 travels by rotating the traveling motors 4ae and 4be with the driving force from the engine and driving tracks 4c and 4d. FIG. 1 shows only the traveling motor 4be.

The revolving unit 5 is arranged on the traveling unit 4. The revolving unit 5 is provided so as to be revolvable with respect to the traveling unit 4 about an axis along the vertical direction by a revolving device (not shown).

A cab 6 as a driver's room is provided at a position on the left side of the front part of the revolving unit 5. The revolving unit 5 accommodates a hydraulic pump, an engine (not shown) and the like. Unless otherwise specified in the present embodiment, the front, back, left and right will be described with reference to the driver's seat in the cab 6. The direction in which the driver's seat faces the front is the front direction F, and the direction facing the front direction is the back direction B. The right side and the left side in the lateral direction when the driver's seat faces the front are the right direction R and the left direction L, respectively.

The cab 6 includes a door 6a on the left side surface arranged on the opposite side of the work implement 3.

The work implement 3 includes a boom 7, an arm 8, and an excavation bucket 9, and is attached to the front center position of the revolving unit 5. Specifically, the work implement 3 is located on the right side of the cab 6. The base end portion of the boom 7 is rotatably connected to the revolving unit 5. Further, the tip end portion of the boom 7 is rotatably connected to the base end portion of the arm 8. The tip of the arm 8 is rotatably connected to the excavation bucket 9. The excavation bucket 9 is attached to the arm 8 so that its opening can face the direction (backward) of the vehicle main body 2. A hydraulic excavator in which the excavation bucket 9 is attached in such a direction is called a backhoe. Further, hydraulic cylinders 10 to 12 (a boom cylinder 10, an arm cylinder 11 and a bucket cylinder 12) are arranged so as to correspond to the boom 7, the arm 8 and the excavation bucket 9, respectively. The work implement 3 is driven by driving these hydraulic cylinders 10 to 12 (an example of an actuator). As a result, work, such as excavation, is performed.

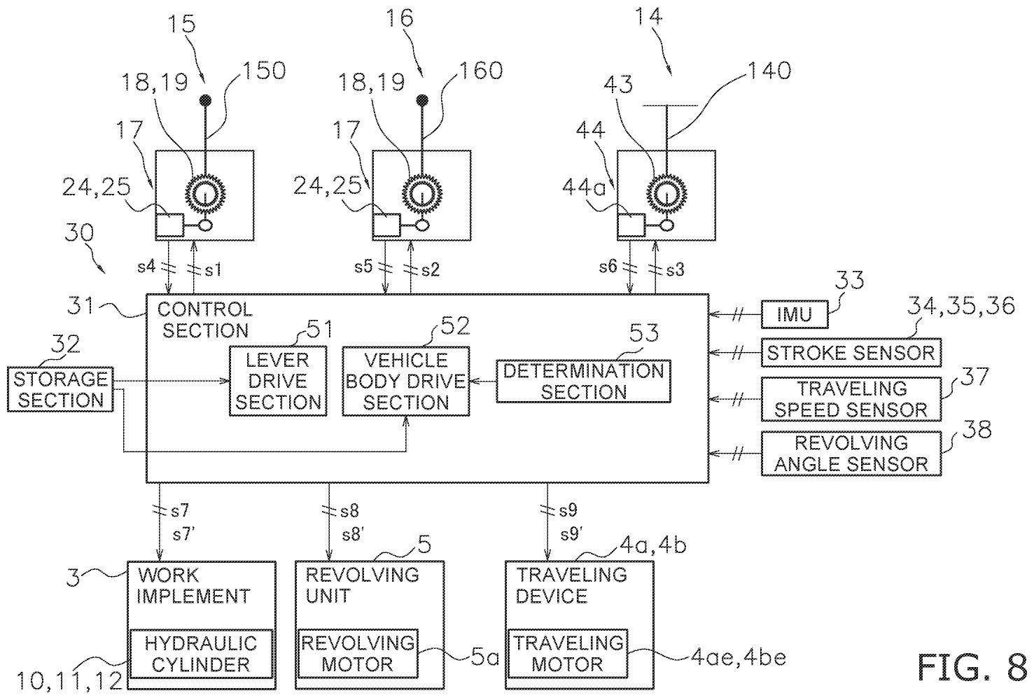

Further, the vehicle main body 2 is provided with a control system 30 as shown in FIG. 8, which will be described later. The control system 30 controls the work implement 3, the revolving unit 5, the traveling devices 4a and 4b, and the drive sections 17 and 44 described later.

(Cab 6)

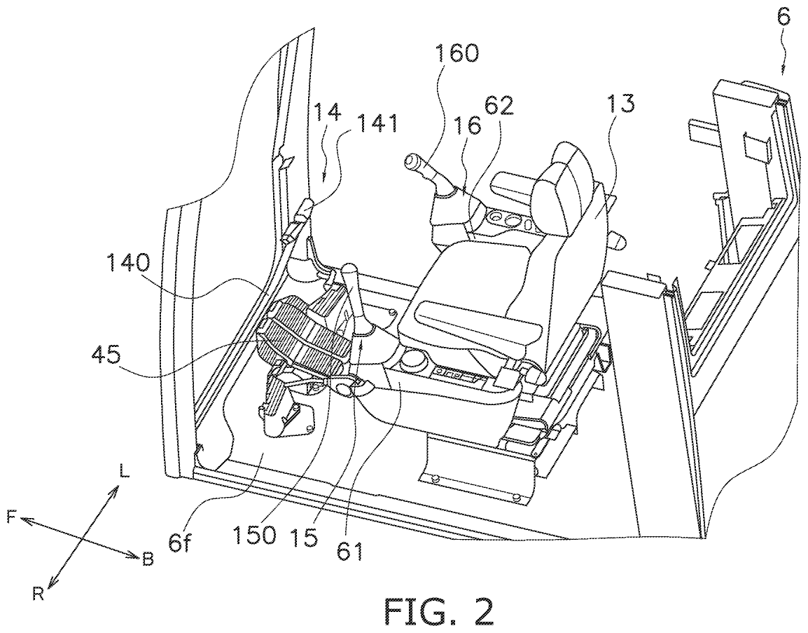

FIG. 2 is a perspective view showing the inside of the cab 6.

A driver's seat 13, a traveling lever unit 14, a left work implement operating lever unit 15, and a right work implement operating lever unit 16 are provided in the cab 6.

The traveling lever unit 14 is arranged on the front side of the driver's seat 13. By pushing the traveling lever 140 (an example of an operating lever) of the traveling lever unit 14 forward, the vehicle main body 2 travels forward, and by pulling the traveling lever 140 toward an operator, the vehicle main body 2 travels backward. Depending on the direction of the revolving unit, the forward movement and the backward movement may be reversed.

The left work implement operating lever unit 15 is provided on the console box 61 arranged on the left side of the driver's seat 13. The left work implement operating lever 150 (an example of an operating lever) of the left work implement operating lever unit 15 can be tilted in four directions, front, back, left and right.

The arm 8 is pushed out by tilting the left work implement operating lever 150 forward, and the arm 8 is pulled in by tilting the left work implement operating lever 150 backward. Further, the revolving unit 5 revolves to the right by tilting the left work implement operating lever 150 toward the driver's seat 13, and the revolving unit 5 revolves to the left by tilting the left work implement operating lever 150 to the opposite side of the driver's seat 13. In the state where the left work implement operating lever 150 is arranged in the neutral position in the front, back, left and right, the revolving unit 5 and the arm 8 are held at that position while being stopped.

The right work implement operating lever unit 16 is provided on the console box 62 arranged on the right side of the driver's seat 13. The right work implement operating lever 160 (an example of the operating lever) of the right work implement operating lever unit 16 can be tilted in four directions of front, back, left, and right.

The boom 7 is lowered by tilting the right work implement operating lever 160 forward, and the boom 7 is raised by tilting the right work implement operating lever 160 backward. The excavation bucket 9 dumps by tilting the right work implement operating lever 106 to the opposite side of the driver's seat 13, and the excavation bucket 9 operates excavation by tilting the right work implement operating lever 160 to the driver's seat 13 side. In the state where the right work implement operating lever 160 is arranged in the neutral position in the front, back, left and right, the boom 7 and the excavation bucket 9 do not move and are held at that position.

(Traveling Lever Unit 14)

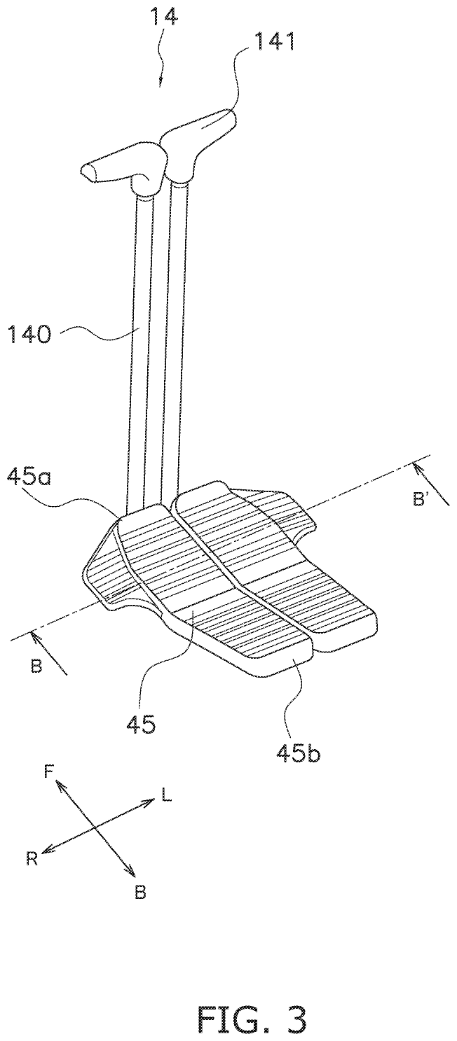

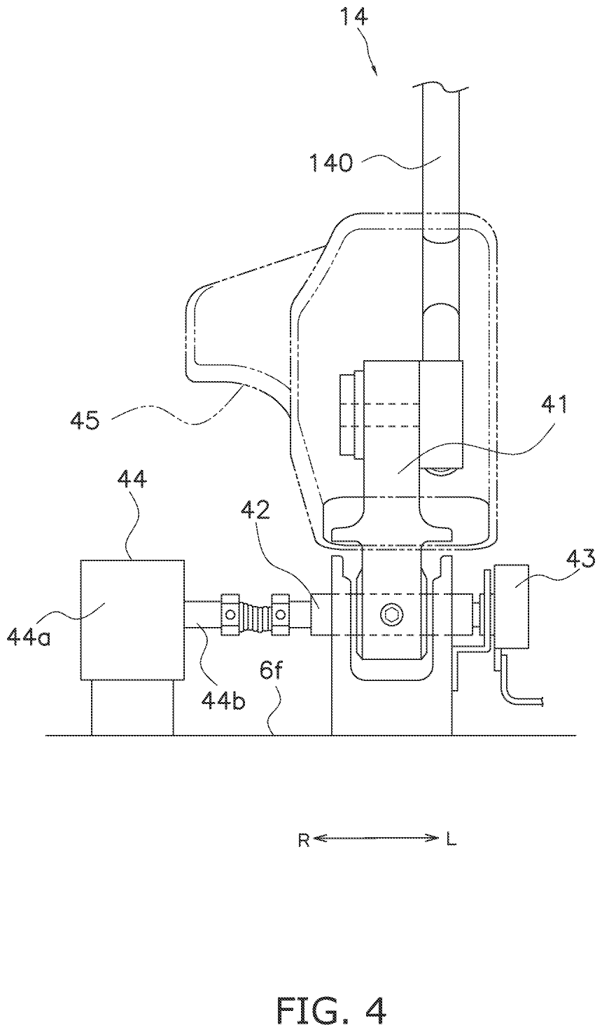

FIG. 3 is a perspective view of the traveling lever unit 14. FIG. 4 is a cross-sectional view from the arrow direction of the BB′ line on FIG. 3.

The traveling lever unit 14 includes a traveling lever 140, a connecting part 41, a shaft part 42, a potentiometer 43, a drive section 44, and a traveling pedal 45.

The traveling lever 140 extends upward from the floor 6f of the cab 6. A grip part 141 that is gripped by the operator during operation is provided at the upper end of the traveling lever 140. The connecting part 41 connects between the lower part of the traveling lever 140 and the shaft part 42. The connecting part 41 is fixed to each of the traveling lever 140 and the shaft part 42. The shaft part 42 is arranged along the left-right direction.

The potentiometer 43 is provided at one end of the shaft part 42. When the traveling lever 140 is tilted in the front-back direction, the connecting part 41 fixed to the traveling lever 140 also moves in the front-back direction, and the shaft part 42 rotates together with the connecting part 41. By detecting the position of the shaft part 42 with the potentiometer 43, the operating position of the traveling lever 140 can be detected.

The drive section 44 includes an electric motor 44a connected to the other end of the shaft part 42. The output shaft 44b of the electric motor 44a is connected to the shaft part 42, and the electric motor 44a can rotationally drive the shaft portion 42. By rotationally driving the shaft part 42, the traveling lever 140 can be tilted and moved in the front-back direction.

The traveling pedal 45 is arranged on the upper side of the connecting part 41, and as shown in FIG. 3, by stepping on the front end 45a so as to move downward, the traveling lever 140 also moves forward and the hydraulic excavator 1 can be traveled forward. Further, by stepping on the back end 45b so as to move downward, the traveling lever 140 also moves backward, and the hydraulic excavator 1 can be traveled backward.

(Left Work Implement Operating Lever Unit 15 and Right Work Implement Operating Lever Unit 16)

Since the left work implement operating lever unit 15 and the right work implement operating lever unit 16 include the same configuration, the left work implement operating lever unit 15 will be described as an example.

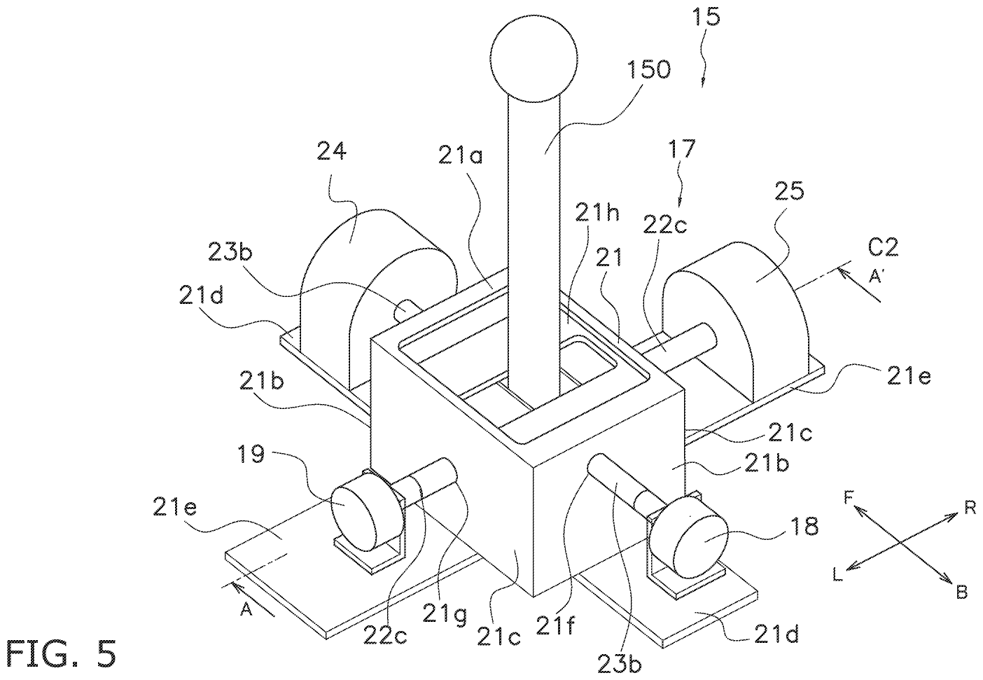

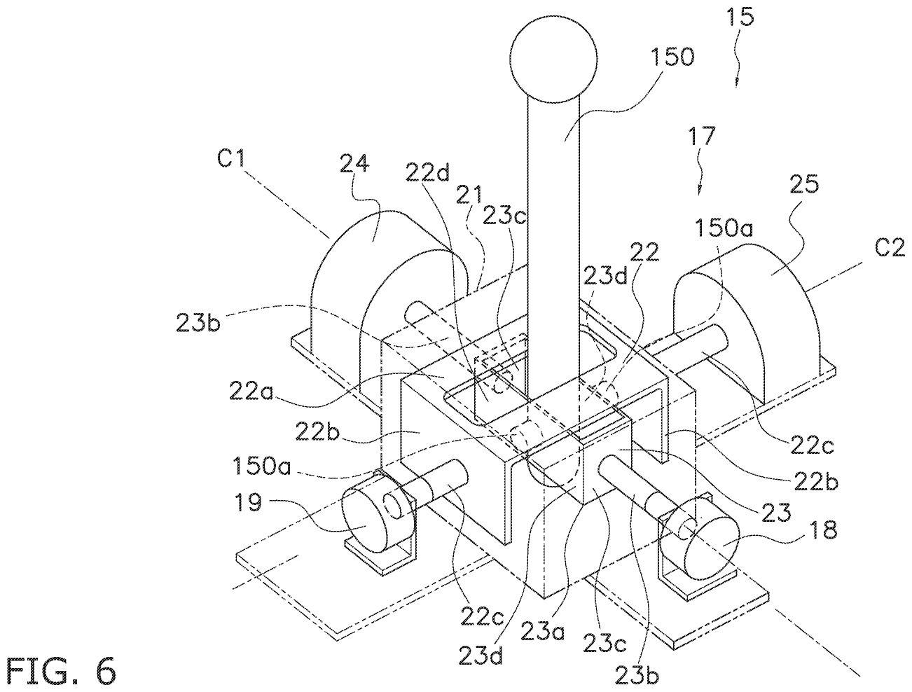

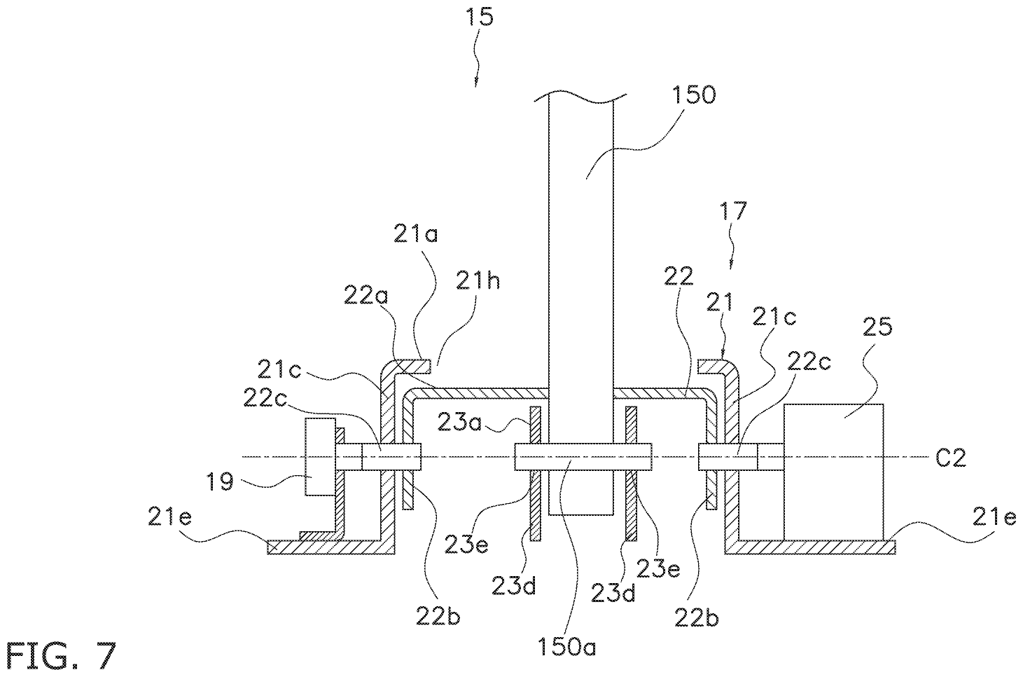

FIG. 5 is a perspective view schematically showing the external configuration of the left work implement operating lever unit 15. FIG. 6 is a perspective view schematically showing the internal configuration of the left work implement operating lever unit 15. FIG. 7 is a cross-sectional view from the arrow direction of AA′ line in FIG. 5.

As shown in FIG. 6, the left work implement operating lever unit 15 includes a first support frame 21, a second support frame 22, a third support frame 23, and a drive section 17.

(First Support Frame 21)

The first support frame 21 is fixed to the frame of the console box 61, and supports the left work implement operating lever 150 so as to be tiltable back and forth and left and right via the second support frame 22 and the third support frame 23.

For example, as shown in FIG. 5, the first support frame 21 includes a box shape, and includes an upper surface 21a, a pair of side surfaces 21b, a pair of side surfaces 21c, a pair of arrangement surfaces 21d, and a pair of arrangement surfaces. 21e.

A square shape through hole 21h is formed on the upper surface 21a in a plan view.

The pair of side surfaces 21b are provided so as to face downward from each of the front end and the back end of the upper surface 21a. The pair of side surfaces 21b are arranged so as to face each other in the front-back direction. Through holes 21f are formed in each of the pair of side surfaces 21b. Only one through hole 21f is shown.

The pair of side surfaces 21c are provided so as to face downward from each of the left end and the right end of the upper surface 21a. The pair of side surfaces 21c are arranged so as to face each other in the left-right direction. Through holes 21g are formed in each of the pair of side surfaces 21c. Only one through hole 21g is shown.

A box shape is formed by the upper surface 21a, the pair of side surfaces 21b, and the pair of side surfaces 21c.

The pair of arrangement surfaces 21d are provided so as to be perpendicular to the side surface 21b and extend outward from the lower ends of each of the pair of side surfaces 21b.

The pair of arrangement surfaces 21e are provided so as to be perpendicular to the side surfaces 21c and extend outward from the lower ends of each of the pair of side surfaces 21c.

(Second Support Frame 22)

In FIG. 6, the first support frame 21 is shown by a two-dot chain line, and the inside configuration of the first support frame 21 is shown by a solid line.

The second support frame 22 is tilted in accordance with the tilt of the left work implement operating lever 150 in the front-back direction. The second support frame 22 does not rotate with respect to the left-right tilt of the left work implement operating lever 150, and supports the left-right tilt of the left work implement operating lever 150.

The second support frame 22 is rotatably arranged inside the first support frame 21 with respect to the first support frame 21. As shown in FIG. 7, the second support frame 22 is formed in an inverted U shape when viewed along the front-back direction.

The second support frame 22 includes an upper surface 22a, a pair of side surfaces 22b, and a shaft 22c. The pair of side surfaces 22b are provided so as to face downward from the left and right ends of the upper surface 22a. The upper surface 22a is provided with a through hole 22d formed along the left-right direction. Further, the width of the through hole 22d in the front-back direction is set to be substantially the same as the diameter of the left work implement operating lever 150. The left work implement operating lever 150 tilts in the left-right direction along the through hole 22d.

The shaft 22c is provided on each of the pair of side surfaces 22b along the left-right direction so as to project outward. The shaft 22c on the left side surface 22b is provided from the left side surface 22b toward the left, and the shaft 22c on the right side surface 22b is provided from the right side surface 22b toward the right. The pair of shafts 22c are rotatably inserted into the through holes 21g (see FIG. 5) formed in each of the pair of side surfaces 21c.

(Third Support Frame 23)

The third support frame 23 rotates in accordance with the tilt of the left work implement operating lever 150 in the left-right direction. The third support frame 23 does not rotate with respect to the tilt of the left work implement operating lever 150 in the front-back direction, and supports the rotation of the left work implement operating lever 150.

The third support frame 23 is rotatably arranged inside the first support frame 21 with respect to the first support frame 21. The third support frame 23 is arranged inside the second support frame 22.

As shown in FIG. 6, the third support frame 23 includes a frame part 23a and a shaft 23b. The frame part 23a includes a rectangular shape formed long in the front-back direction in a plan view. The frame part 23a surrounds the left work implement operating lever 150 in a plan view. The left work implement operating lever 150 is tilted along the front-back direction of the frame part 23a. The frame part 23a includes a pair of side surfaces 23c and a pair of side surfaces 23d. The pair of side surfaces 23c are arranged so as to face each other in the front-back direction. The pair of side surfaces 23d are arranged so as to face each other in the left-right direction. The side surface 23d is formed longer than the side surface 23c in a plan view. Through holes 23e are formed in each of the pair of side surfaces 23d as shown in FIG. 5.

The shaft 23b is provided on each of the pair of side surfaces 23c along the front-back direction so as to project outward. The shaft 23b provided on the front side surface 23c is arranged from the front side surface 23c toward the front, and the shaft 23b provided on the back side surface 23c is arranged from the back side surface 23c toward the back. The pair of shafts 23b are rotatably inserted into through holes 21f (see FIG. 5) formed in each of the pair of side surfaces 21b.

As shown in FIG. 5, the left work implement operating lever 150 includes a shaft 150a protruding in each of the left and right directions at its root portion. The shaft 150a is rotatably inserted into each through holes 23e of the pair of side surfaces 23d. The shaft 150a and the pair of shafts 22c of the second support frame 22 described above are coaxially arranged (see axis C2). The pair of shafts 23b of the third support frame 23 are arranged coaxially (see axis C1).

As a result, for example, when the left work implement operating lever 150 is tilted in the front-back direction, the left work implement operating lever 150 rotates about the shaft 150a with respect to the third support frame 23. At this time, since the frame part 23a of the third support frame 23 is formed long in the front-back direction, the left work implement operating lever 150 can be tilted in the front-back direction without interfering with the frame part 23a.

On the other hand, since the left work implement operating lever 150 comes into contact with the edge of the through hole 22d, the second support frame 22 rotates about the shaft 22c as the left work implement operating lever 150 rotates in the front-back direction. Since the shaft 150a and the pair of shafts 22c of the second support frame 22 described above are arranged on the coaxial C2, the left work implement operating lever 150 is tilted in the front-back direction about the axis C2.

Further, when the left work implement operating lever 150 is tilted in the left-right direction, the left work implement operating lever 150 rotates about the shaft 23b together with the third support frame 23. When the left work implement operating lever 150 is tilted in the left-right direction, the left work implement operating lever 150 moves along the through hole 22d of the second support frame 22, so that the left work implement operating lever 150 can be tilted in the left-right direction without interfering with the upper surface 22a of the second support frame 22. Since the pair of shafts 23b of the third support frame 23 are arranged on the coaxial C1, the left work implement operating lever 150 is tilted in the left-right direction about the axis C1.

(Drive Section 17)

The drive section 17 drives the left work implement operating lever 150 in accordance with the lever motion stored in the storage section 32 described later.

The drive section 17 includes a first motor 24 and a second motor 25.

(First Motor 24)

The first motor 24 is an electric motor and is connected to one shaft 23b of the pair of shafts 23b of the third support frame 23. The first motor 24 is fixed to the arrangement surface 21d.

The first motor 24 can tilt the left work implement operating lever 150 in the left-right direction by imparting force to the shaft 23b.

(Second Motor 25)

The second motor 25 is an electric motor and is connected to one shaft 22c of the pair of shafts 22c of the second support frame 22. The second motor 25 is fixed to the arrangement surface 21e.

The second motor 25 can tilt the left work implement operating lever 150 in the front-back direction by imparting force to the shaft 22c.

(First Potentiometer 18)

As shown in FIG. 5, the first potentiometer 18 is connected to the pair of shafts 23b of the third support frame 23. The first potentiometer 18 is fixed to the arrangement surface 21d.

The first potentiometer 18 detects the tilted position of the left work implement operating lever 150 in the left-right direction by detecting the rotational position of the shaft 23b. A command signal is transmitted based on this tilted position, and the revolving unit 5 revolves.

(Second Potentiometer 19)

The second potentiometer 19 is connected to a pair of shafts 22c of the second support frame 22. The second potentiometer 19 is fixed to the arrangement surface 21e of the first support frame 21.

The second potentiometer 19 detects the tilted position of the left work implement operating lever 150 in the front-back direction by detecting the rotational position of the shaft 22c. A command signal is transmitted based on this tilted position, and the arm 8 is pushed out or pulled in.

(Control System 30)

FIG. 8 is a block diagram showing the configuration of the control system 30. In FIG. 8, the first potentiometer 18 and the second potentiometer 19 are shown together. The first motor 24 and the second motor 25 are shown together.

The control system 30 includes a control section 31, a storage section 32, an IMU 33, stroke sensors 34, 35, 36, a traveling speed sensor 37, and a revolving angle sensor 38.

The control section 31 includes a processor, such as a CPU (Central Processing Unit), and a main memory including a non-volatile memory, such as a ROM (Read Only Memory), and a volatile memory, such as a RAM (Random Access Memory). The control section 31 reads out the program stored in the storage section 32, expands the program on the main memory, and executes a predetermined process according to the program. The program may be distributed to the control system 30 via the network.

The storage section 32 stores the predetermined motion of the hydraulic excavator 1 for automatic operation in time series. The predetermined motion of the hydraulic excavator 1 includes at least one of the motion of the work implement 3, the revolving motion of the revolving unit 5, and the traveling motion of the traveling devices 4a and 4b. In the present embodiment, the storage section 32 is provided separately from the control section 31, but may be provided in the control section 31.

Further, the storage section 32 stores the lever motion of the left work implement operating lever 150, the right work implement operating lever 160, and the traveling lever 140, like performing the predetermined motion of the hydraulic excavator 1 in time series in addition to the predetermined motion of the hydraulic excavator 1. This lever motion can be said to be a motion corresponding to the predetermined motion of the hydraulic excavator 1.

The predetermined motion and the lever motion stored in the storage section 32 can be created by the operator, for example, using teaching playback. The teaching playback means that the operator operates the left work implement operating lever 150, the right work implement operating lever 160 and the traveling lever 140 and the storage section 32 stores the operation procedure.

The control section 31 includes a lever drive section 51, a vehicle body drive section 52, and a determination section 53.

The lever drive section 51 controls the left work implement operating lever unit 15, the right work implement operating lever unit 16 and the traveling lever unit 14 so as to perform the lever motion stored in the storage section 32. The lever drive section 51 transmits drive signals s1, s2 and s3 to each of the left work implement operating lever unit 15, the right work implement operating lever unit 16 and the traveling lever unit 14 so as to perform predetermined lever motion stored in the storage section 32.

The left work implement operating lever unit 15 drives the first motor 24 and the second motor 25 based on the drive signal s1 to drive the left work implement operating lever 150. The right work implement operating lever unit 16 drives the first motor 24 and the second motor 25 based on the drive signal s2 to drive the right work implement operating lever 160. The traveling lever unit 14 drives the electric motor 44a based on the drive signal s3 to drive the traveling lever 140.

The vehicle body drive section 52 controls the work implement 3, the revolving unit 5, or the traveling devices 4a and 4b so as to perform the predetermined motion in the storage section 32. The vehicle body drive section 52 transmits a control signal s7 to the work implement 3, transmits a control signal s8 to the revolving unit 5, and transmits a control signal s9 to the traveling devices 4a and 4b so as to perform the predetermined motion in the storage section 32. As an example, the EPC valve that has received the control signal s7 is driven, the hydraulic fluid is supplied to the hydraulic cylinders 10 to 12, and the work implement 3 operates. Further, upon receiving the control signal s8, the revolving motor 5a is driven to revolve the revolving unit 5. Upon receiving the control signal s9, the traveling motors 4ae and 4be provided in each of the traveling devices 4a and 4b drive the tracks 4c and 4d, and the traveling unit 4 moves forward or backward. The hydraulic cylinders 10 to 12 are examples of actuators of a work implement. The traveling motors 4ae and 4be are examples of actuators of a traveling device. The revolving motor 5a is an example of an actuator of a revolving unit.

The IMU (Inertial Measurement Unit) 33 includes a three-axis gyro and a three-way accelerometer, and can detect three-dimensional angular velocity and acceleration. The stroke sensor 34 detects the stroke of the boom cylinder 10. The stroke sensor 35 detects the stroke of the arm cylinder 11. The stroke sensor 36 detects the stroke of the bucket cylinder 12. The posture of work implement 3 can be detected by the stroke sensors 34 to 36.

The traveling speed sensor 37 detects the traveling speed of the traveling devices 4a and 4b. The revolving angle sensor 38 detects the revolving angle of the revolving unit 5.

The determination section 53 determines the operator's operation interruption during the automatic operation of the predetermined motion. The determination section 53 determines whether or not the motion of the left work implement operating lever 150, the right work implement operating lever 160, or the traveling lever 140 matches the lever motion stored in the storage section 32.

The left work implement operating lever unit 15 transmits the position signal s4 of the left work implement operating lever 150 detected by the first potentiometer 18 and the second potentiometer 19 to the control section 31. The right work implement operating lever unit 16 transmits the position signal s5 of the right work implement operating lever 160 detected by the first potentiometer 18 and the second potentiometer 19 to the control section 31. The traveling lever unit 14 transmits the position signal s6 of the traveling lever 140 or the traveling pedal 45 detected by the potentiometer 43 to the control section 31.

The determination section 53 determines whether or not lever motion is different from the predetermined lever motion stored in the storage section 32 by the operator's operating any of the left work implement operating lever 150, the right work implement operating lever 160, and the traveling lever 140, based on the position signals s4 to s6. Since the first motor 24, the second motor 25, or the electric motor 44a is driven so as to perform the lever motion stored in the storage section 32, the operator needs to operate against the driving force of the motor in order to interrupt the operation.

When the determination section 53 determines that the left work implement operating lever 150, the right work implement operating lever 160, or the traveling lever 140 has been operated differently from the predetermined lever motion, the vehicle body drive section 52 generates control signals s7′, s8′, and s9′ corresponding to different motion based on position signals s4 to s6 and transmits control signals s7′, s8′, and s9′ to the work implement 3, the revolving unit 5, or the traveling devices 4a and 4b. The work implement 3 operates based on the control signal s7′, the revolving unit 5 operates based on the control signal s8′, and the traveling devices 4a and 4b operate based on the control signal s9′. The vehicle body drive section 52 creates control signals s7′, s8′, and s9′ so as to operate the lever larger or smaller than the lever operating position when performing the predetermined motion with the difference between the lever operating position when performing the predetermined motion and the different lever operating position.

As a result, even when the operator interrupts and operates the lever during the automatic operation in which the predetermined motion is performed, the motion corresponding to the operator's lever operation can be performed, and the interrupt operation can be smoothly performed during the automatic operation.

Further, when the determination section 53 determines that the motion of the left work implement operating lever 150, the right work implement operating lever 160 or the traveling lever 140 matches the lever motion stored in the storage section 32 based on the position signals s4 to s6, the vehicle body drive section 52 generates the control signals s7, s8 and s9 so as to perform the predetermined motion stored in the storage section 32 and transmits the control signals s7, s8 and s9. Here, since the first motor 24, the second motor 25, or the electric motor 44a is driven so as to perform the lever motion stored in the storage section 32, when the operator who has interrupted the automatic operation releases his/her hand from the lever, the left work implement operating lever 150, the right work implement operating lever 160, or the traveling lever 140 returns to the original lever operating position. This return is determined by the determination section 53 based on the position signals s4 to s6.

As a result, when the operator interrupts the automatic operation in which the predetermined motion is performed and performs operation, the motion corresponding to the operator's operation can be performed, and the interrupt operation can be smoothly performed.

In addition, in the state where the operator puts his/her hand on the left work implement operating lever 150, the right work implement operating lever 160, or the traveling lever 140, when it is necessary to operate larger (addition) or smaller (subtraction) than the automatic operation, it is possible to interrupt the automatic operation smoothly.

When the determination section 53 determines that the positions of the left work implement operating lever 150, the right work implement operating lever 160, or the traveling lever 140 matches the positions of the lever motion for performing a predetermined motion, it is possible to return the automatic operation.

<Operation>

The operation of the hydraulic excavator 1 according to the embodiment of the present disclosure will be described below.

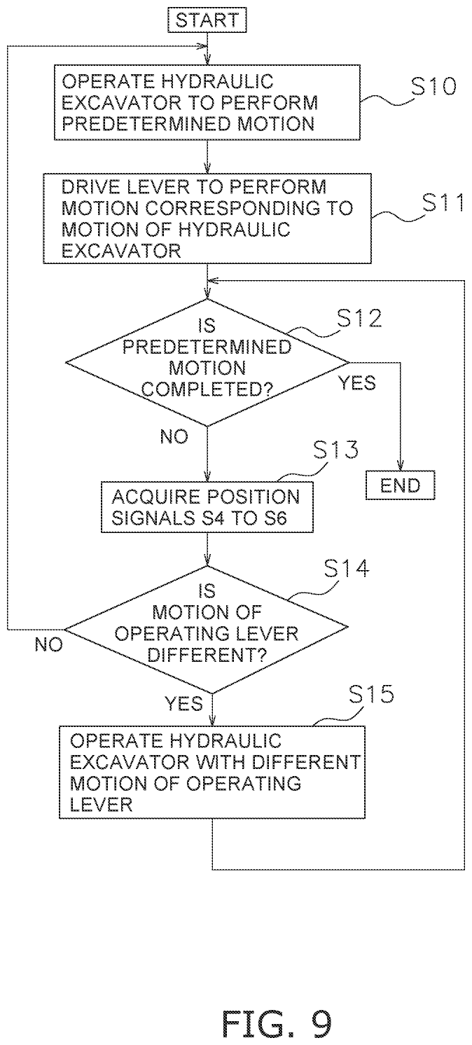

FIG. 9 is a flow chart for explaining the operation of the hydraulic excavator 1 according to the embodiment of the present disclosure.

First, in step S10, the hydraulic excavator 1 is performed so that the automatic operation in which the predetermined motion stored in the storage section 32 is performed. Specifically, the vehicle body drive section 52 transmits the control signal s7 to the hydraulic cylinders 10 to 12 of the work implement 3, transmits the control signal s8 to the revolving motor 5a of the revolving unit 5, and transmits the control signal s9 to the traveling motors 4ae and 4be of the traveling devices 4a and 4b so as to perform the predetermined motion stored in the storage section 32 while feeding back the detected values of the IMU 33 and various sensors 34 to 38

Next, in step S11, the lever motion is performed so as to perform the motion corresponding to the motion of the hydraulic excavator 1. Specifically, the lever drive section 51 transmits the drive signal s1 to the left work implement operating lever unit 15, transmits the drive signal s2 to the right work implement operating lever unit 16 and transmits the drive signal s3 to the traveling lever unit 14 so as to perform the lever motion stored in the storage section 32. The lever motion stored in the storage section 32 is motion like performing the motion of the work implement 3, the revolving unit 5, and the traveling devices 4a and 4b stored in the storage section 32, and is motion corresponding to the motion of the work implement 3, the revolving unit 5, and the traveling devices 4a and 4b stored in the storage section 32.

Next, in step S12, the control section 31 determines whether or not the time series of the predetermined motion stored in the storage section 32 has completed. When the time series has not completed, the control section 31 acquires the position signals s4 to s6 of the left work implement operating lever 150, the right work implement operating lever 160, and the traveling lever 140 in step S13.

Next, in step S14, the determination section 53 of the control section 31 determines whether or not the motion of the left work implement operating lever 150, the right work implement operating lever 160, and the traveling lever 140 are different from the predetermined motion stored in the storage section 32.

Next, when it is determined that the lever motion is different from the predetermined motion, in step S15, the vehicle body drive section 52 operates the hydraulic excavator by the different lever motion.

After step S15, the control proceeds to step S12, and in step S12, the control section 31 determines whether or not the time series of the predetermined motion stored in the storage section 32 has completed, and when the time series are not completed, steps S13 and S14 are performed.

When it is determined in step S14 that the lever motion is not different from the predetermined motion (when returning to the position of the original lever motion), the control proceeds to step S11 and the automatic operation is performed in which the predetermined motion stored in the storage section 32 is performed, and lever motion like performing the predetermined motion is performed.

On the other hand, when it is determined in step S12 that the predetermined motion is completed, the control section 31 ends the control.

### Embodiment 2

Hereinafter, the hydraulic excavator of the second embodiment will be described below. The hydraulic excavator 1 of the second embodiment creates the motion by acquiring information on the terrain which is a work target and calculating not by teaching.

<Configuration>

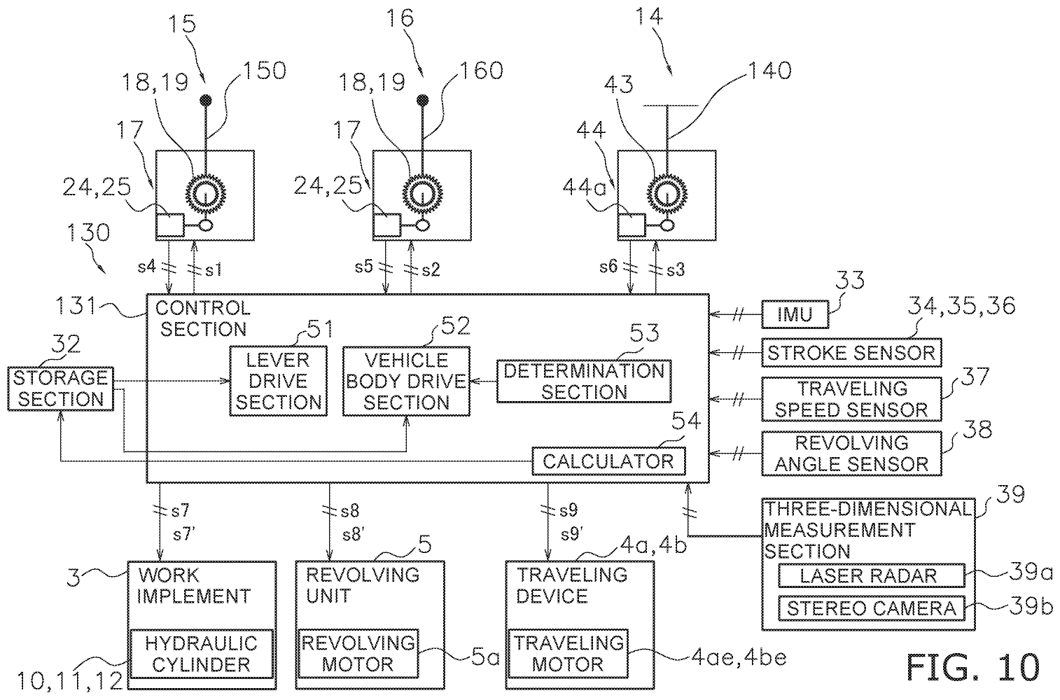

FIG. 10 is a block diagram showing the configuration of the control system 130 according to the second embodiment. The control system 130 of the second embodiment includes a control section 131, a storage section 32, an IMU 33, stroke sensors 34, 35, 36, a traveling speed sensor 37, a revolving angle sensor 38, and a three-dimensional measurement section 39. Further, the control section 131 further includes a calculation section 54 as compared with the control section 31 of the first embodiment.

The three-dimensional measurement section 39 measures the position or shape of the work target. The three-dimensional measurement section 39 includes a laser radar 39a, which is a kind of laser measurement device, and a stereo camera 39b. The laser radar 39a irradiates the work target with a laser, receives the laser light scattered by the work target, and transmits the light reception data to the control section 131. The calculation section 54 of the control section 131 measures the three-dimensional shape of the work target and the relative position with the work target based on the received light data.

The stereo camera 39b includes two cameras. The image data taken by the two cameras is transmitted to the control section 131. The calculation section 54 of the control section 131 performs stereo processing based on the image data captured by each camera, and measures the three-dimensional shape of the work target and the relative position with respect to the work target. Either the laser radar 39a or the stereo camera 39b may be provided.

The calculation section 54 calculates the motion of the hydraulic excavator 1 from the three-dimensional shape and the relative position with the work target obtained from the detection values of the IMU 33, various sensors 34 to 38 and the three-dimensional measurement section 39. The calculated motion is stored in the storage section 32. Then, the work implement 3, the revolving unit 5 and the traveling device 4a are controlled so as to perform the predetermined motion stored in the storage section 32, and the left work implement operating lever 150, the right work implement operating lever 160 and the traveling lever 140 are operated so as to perform the lever motion like performing the predetermined motion.

The hydraulic excavator 1 (an example of a work machine) of the embodiment includes the left work implement operating lever 150 (an example of an operating member), the right work implement operating lever 160 (an example of an operating member), and the traveling lever 140 (an example of an operating member), the drive sections 17 and 44, and the control sections 31 and 131 (an example of a controller). The drive sections 17 and 44 operate the left work implement operating lever 150, the right work implement operating lever 160 and the traveling lever 140. The control sections 31 and 131 outputs the control signals s7, s8, and s9 to the hydraulic cylinders 10 to 12 (example of actuators), the revolving motor 5a (an example of an actuator) of the revolving unit 5, and the traveling motors 4ae and 4be (example of actuators) of the traveling devices 4a and 4b. The control sections 31 and 131 outputs the drive signals s1, s2 and s3 to the drive sections 17 and 44. The drive signals s1, s2 and s3 gives motion corresponding to the motion of the hydraulic cylinders 10 to 12, the revolving motors 5a, and the traveling motors 4ae and 4be to the left work implement operating lever 150, the right work implement operating lever 160 and the traveling lever 140.

As a result, since the operator can visually recognize the motion of the left work implement operating lever 150, the right work implement operating lever 160, and the traveling lever 140 when operating the hydraulic excavator 1, so that it is possible to easily confirm the motion of the left work implement operating lever 150, the right work implement operating lever 160 and the traveling lever 140.

In the hydraulic excavator 1 of the embodiment (an example of a work machine), the left work implement operating lever 150 and the right work implement operating lever 160 are levers for operating the work implement 3, and the control sections 31 and 131 outputs the control signal s7 to the hydraulic cylinders 10 to 12 (example of actuators) of work implement 3 based on the predetermined motion.

By outputting the control signal s7 to the work implement 3 in this way, the work implement 3 can be operated as the predetermined motion.

In the hydraulic excavator 1 of the embodiment (an example of a work machine), the traveling lever 140 is a lever for operating the traveling devices 4a and 4b of the hydraulic excavator 1. The control sections 31 and 131 output the control signal s9 to the traveling motors 4ae and 4be (example of actuators) of the traveling devices 4a and 4b based on the motion of the traveling lever 140.

By outputting the control signal s9 to the traveling devices 4a and 4b in this way, the traveling devices 4a and 4b can be operated according to the predetermined motion stored in the storage section 32.

In the hydraulic excavator 1 of the embodiment (an example of a work machine), when the left work implement operating lever 150, the right work implement operating lever 160 or the traveling lever 140 is operated by the operator and the motion of the left work implement operating lever 150, the right work implement operating lever 160 or the traveling lever 140 is different from the motion corresponding to the motion of the hydraulic cylinders 10 to 12, the revolving motor 5a of the revolving unit 5, or the traveling devices 4a and 4b by the operator's operating, the control sections 31 and 131 output the control signals s7′, s8′, and s9′ based on the different motion of the left work implement operating lever 150, the right work implement operating lever 160 or the traveling lever 140.

As a result, in the automatic operation that the left work implement operating lever 150, the right work implement operating lever 160 and the traveling lever 140 are automatically driven so that the hydraulic excavator 1 performs the predetermined motion, the operator can easily interrupt the automatic operation by operating the left work implement operating lever 150, the right work implement operating lever 160 or the traveling lever 140.

The hydraulic excavator 1 of the embodiment (an example of a work machine) includes the first potentiometer 18, the second potentiometer 19, and the potentiometer 43 (an example of position detection sections). The first potentiometer 18 and the second potentiometer 19 detect the position of the left work implement operating lever 150. The first potentiometer 18 and the second potentiometer 19 detect the position of the right work implement operating lever 160. The potentiometer 43 detects the position of the traveling lever 140. The control sections 31 and 131 includes the determination section 53. The determination section 53 determines whether or not the motion of the left work implement operating lever 150, the right work implement operating lever 160, or the traveling lever 140 is different from the motion corresponding to the motion of the hydraulic cylinders 10 to 12 of the work implement 3, the revolving motor 5a of the revolving unit 5, and the traveling motors 4ae and 4be of the traveling devices 4a and 4b based on the position of the left work implement operating lever 150, the right work implement operating lever 160, or the traveling lever 140 detected by the first potentiometer 18, the second potentiometer 19, and the potential meter 43.

Thereby, it is possible to determine whether or not the motion interrupts the automatic operation based on the position of the left work implement operating lever 150, the right work implement operating lever 160, or the traveling lever 140.

The hydraulic excavator 1 (an example of a work machine) of the embodiment includes the storage section 32. The storage section 32 stores the motion of the hydraulic cylinders 10 to 12, the revolving motor 5a, and the traveling motors 4ae and 4be. The motion of the hydraulic cylinders 10 to 12, the revolving motor 5a, the traveling motors 4ae, and 4be stored in the storage section 32 is created by the teaching playback.

For example, by teaching the operation of a skilled operator and storing the operation in the storage section 32, it is possible to confirm the operation of the operating lever by the skilled operator.

In the hydraulic excavator 1 (an example of a work machine) of the embodiment, the control section 131 includes a three-dimensional measurement section 39 (an example of a terrain information acquisition section) and a calculation section 54. The three-dimensional measurement section 39 acquires terrain information. The calculation section 54 calculates the motion of the hydraulic cylinders 10 to 12 (examples of actuators), the revolving motor 5a (an example of an actuator) of the revolving unit 5, and the traveling motors 4ae and 4be (examples of actuators) of the traveling devices 4a and 4b.

As a result, the motion can be automatically created at the construction site, and the left work implement operating lever 150, the right work implement operating lever 160, or the traveling lever 140 can be driven based on the motion.

The disclosed control method for the hydraulic excavator 1 (an example of a work machine) includes step S10 (an example of a first output step) and step S11 (an example of a second output step). In step S10, the control signals s7, s8, and s9 for operating the hydraulic cylinders 10 to 12 (examples of actuators) of work implement 3, the revolving motor 5a (an example of an actuator) of the revolving unit 5, and the traveling motors 4ae and 4be (examples of actuators) of the traveling devices 4a and 4b are output. In step S11, the drive signals s1, s2 and s3 giving the motion corresponding to the motion of the hydraulic cylinders 10 to 12, the revolving motor 5a and the traveling motors 4ae and 4be to the left work implement operating lever 150, the right work implement operating lever 160 and the traveling lever 140 are output to the left work implement operating lever 150 (an example of an operating member), the right work implement operating lever 160 (an example of an operating member) and the traveling lever 140 (an example of an operating member).

As a result, the operator can visually recognize the motion of the left work implement operating lever 150, the right work implement operating lever 160, and the traveling lever 140 when operating the hydraulic excavator 1, so that it is possible to easily confirm the motion of the left work implement operating lever 150, the right work implement operating lever 160 and the traveling lever 140.

Although one embodiment of the present invention has been described above, the present invention is not limited to the above embodiment, and various modifications can be made without departing from the gist of the invention.

In the above embodiment, the left work implement operating lever 150, the right work implement operating lever 160 and the traveling lever 140 are driven, but any one of them may be driven, or only the left work implement operating lever 150 and the right work implement operating lever 160 may be driven.

In the above embodiment, the determination section 53 detects the operator's operation of the left work implement operating lever 150, the right work implement operating lever 160 and the traveling lever 140 only by the potentiometer, but this is not limited to the potentiometer. For example, in the state wherein the lever is further equipped with a pressure sensor or the like, when it detects the grip of the operator and the detection position by the potentiometer is different, it may be detected that different motion have been performed by the operator.

In the above embodiment, the predetermined motion is obtained by teaching or calculation from the terrain information, but it is not limited to this, and the motion created in advance may be stored in the storage section 32 via the Internet.

In the above embodiment, the hydraulic excavator has been described as an example of the work machine, but the work machine may not be limited to the hydraulic excavator, and may be a wheel loader or the like.

According to the work machine and the control method for the work machine of the present invention, the effect that the operator can easily confirm the operation of the operating lever is exhibited, which is useful as a hydraulic excavator or the like.

1. A work machine comprising:
an operating member;
a drive section configured to operate the operating member; and
a controller configured to output a control signal to operate an actuator of a work implement or a traveling device of the work machine, the controller being configured to output a drive signal to the drive section, the drive signal giving a motion corresponding to a motion of the actuator to the operating member, the work machine being configured to operate the operating member based on the drive signal,
when a motion of the operating member operated by an operator is different from the motion corresponding to the motion of the actuator, the controller being configured to output the control signal based on the motion of the operating member operated by the operator.

2. The work machine according to claim 1, further comprising
a position detection section configured to detect a position of the operating member,
the controller including a determination section configured to determine whether or not the motion of the operating member operated by the operator is different from the motion of the operating member corresponding to the motion of the actuator based on the position of the operating member detected by the position detection section.

3. The work machine according to claim 1, further comprising
a storage section configured to store the motion of the actuator,
the motion of the actuator being created by teaching playback.

4. The work machine according to claim 1, wherein
the controller further includes
a terrain information acquisition section configured to acquire terrain information of a work target, and
a calculation section configured to calculate the motion of the actuator based on the terrain information.

5. The control method for a work machine comprising:
a first output step of outputting a control signal operating an actuator;
a second output step of outputting a drive signal to a drive section configured to drive an operating member, the drive signal giving a motion corresponding to a motion of the actuator to the operating member;
a determination step of determining whether or not a motion of the operating member operated by an operator is different from the motion of the operating member corresponding to the motion of the actuator; and
a third output step of outputting the control signal based on the motion of the operating member operated by the operator when it is determined that the motion of the operating member operated by the operator is different from the motion of the operating member corresponding to the motion of the actuator.

6. The work machine according to claim 2, further comprising
a storage section configured to store the motion of the actuator,
the motion of the actuator being created by teaching playback.

7. The work machine according to claim 2, wherein
the controller further includes
a terrain information acquisition section configured to acquire terrain information of a work target, and
a calculation section configured to calculate the motion of the actuator based on the terrain information.
